(19) United States
(12) Patent Application Publication
(10) Pub. No.: US 2013/0022877 A1
(43) Pub. Date: Jan. 24, 2013

(54) Salt Modified Electrostatic Dissipative Polymers

(71) Applicants: Qiwei Lu, Seven Hills, OH (US); Yona Eckstein, Coconut Creek, FL (US)

(72) Inventors: Qiwei Lu, Seven Hills, OH (US); Yona Eckstein, Coconut Creek, FL (US)

(73) Assignee: LUBRIZOL ADVANCED MATERIALS, INC., Cleveland, OH (US)

(21) Appl. No.: 13/638,675

(22) PCT Filed: Mar. 25, 2011
(86) PCT No.: PCT/US11/29949

§ 371 Date: Oct. 1, 2012

Related U.S. Application Data
(60) Provisional application No. 61/320,018, filed on Apr. 1, 2010.

(51) Int. Cl. H01B 1/12; H01M 2/16

(52) U.S. Cl. 429/249; 252/519.21

(57) ABSTRACT

The present invention relates to electrostatic dissipative thermoplatic urethanes (TPU) and compositions thereof. The present invention provides a composition comprising: (a) an inherently dissipative polymer and (b) a halogen-free lithium-containing salt. The invention also provides a shaped polymeric article comprising the inherently dissipative polymer compositions described herein. The invention also provides a process of making the inherently dissipative polymer compositions described herein. The process includes the step of mixing a halogen-free lithium-containing salt into an inherently dissipative polymer.

### BACKGROUND OF THE INVENTION

The present invention relates to electrostatic dissipative polymers and blends, including thermoplastic urethanes (TPU) containing compositions.

The formation and retention of charges of static electricity on the surface of most plastics is well known. Plastic materials have a significant tendency to accumulate static electrical charges due to low electrical conductivity. This type of formation and retention of charges of static electricity can be problematic. The presence of static electrical charges on sheets of thermoplastic film, for example, can cause the sheets to adhere to one another thus making their separation for further processing more difficult. Moreover, the presence of static electrical charges causes dust to adhere to items packaged in a plastic bag, for example, which may negate any sales appeal.

The increasing complexity and sensitivity of microelectronic devices makes the control of static discharge of particular concern to the electronics industry. Even a low voltage discharge can cause severe damage to sensitive devices. The need to control static charge buildup and dissipation often requires the entire assembly environment for these devices to be constructed of partially conductive materials. It also may require that electrostatic protective packages, tote boxes, casings, and covers be made from conductive polymeric materials to store, ship, protect, or support electrical devices and equipment.

The prevention of the buildup of static electrical charges which accumulate on plastics during manufacture or use has been accomplished by the use of various electrostatic dissipative (ESD) materials. These materials can be applied as a coating which may be sprayed or dip coated on the article after manufacture, although this method usually results in a temporary solution. Alternatively, these materials can be incorporated into a polymer used to make the article during processing, thereby providing a greater measure of permanence.

However, the incorporation of these lower molecular weight electrostatic dissipative materials (antistatic agents) into the various matrix or base polymers has its own limitations. For example, the high temperatures required for conventional processing of most polymers may damage or destroy the antistatic agents, thereby rendering them useless with respect to their ESD properties. Moreover, many of the higher molecular weight ESD agents are not miscible with the matrix or base polymers employed. In addition, the use of antistatic agents may only provide short term ESD properties to the compositions in which they are used. Their performance and effectiveness is also often impacted by humidity. There is a need to provide good ESD properties without these drawbacks and limitations.

Furthermore, a large number of antistatic agents are also either cationic or anionic in nature. These agents tend to cause the degradation of plastics, particularly PVC, and result in discoloration or loss of physical properties. Other antistatic agents have significantly lower molecular weights than the base polymers themselves. Often these lower molecular weight antistatic agents possess undesirable lubricating properties and are difficult to incorporate into the base polymer. Incorporation of the lower molecular weight antistatic agents into the base polymers often will reduce the moldability of the base polymer because the antistatic agents can move to the surface of the plastic during processing and frequently deposit a coating on the surface of the molds, possibly destroying the surface finish on the articles of manufacture. In severe cases, the surface of the article of manufacture becomes quite oily and marbleized. Additional problems which can occur with lower molecular weight ESD agents are loss of their electrostatic dissipative capability due to evaporation, the development of undesirable odors, or promotion of stress cracking or crazing on the surface of an article in contact with the article of manufacture.

One of the known lower molecular weight antistatic agents is a homopolymer or copolymer oligomer of ethylene oxide. Generally, use of the lower molecular weight polymers of ethylene oxide or polyethers as antistatic agents are limited by the above-mentioned problems relative to lubricity, surface problems, or less effective ESD properties. Further, these low molecular weight polymers can be easily extracted or abraded from the base polymer thereby relinquishing any electrostatic dissipative properties, and in some instances can also produce undesirably large amounts of unwanted extractable anions, and in particular chloride, nitrate, phosphate, and sulfate anions.

There are several examples of high molecular weight electrostatic dissipative agents in the prior art. In general, these additives have been high molecular weight polymers of ethylene oxide or similar materials such as propylene oxide, epichlorohydrin, glycidyl ethers, and the like. It has been a requirement that these additives be high molecular weight materials to overcome the problems mentioned above. However, these prior art ESD additives do not have a desired balance between electrical conductivity and acceptable low levels of extractable anions and/or cations, in particular, chloride, fluoride, bromide, nitrate, phosphate, sulfate and ammonium, which in turn can cause any manufactured articles containing such ESD additives to have unacceptable properties for some end uses.

For example, U.S. Pat. No. 6,140,405 provides polymers for use with electronic devices, and specifically polymers containing a halogen-containing salt for electrostatic dissipation. These polymers balance the electrical conductivity and acceptable low levels of extractable anions and/or cations, however, they do this by using a halogen-containing ESD additive.

There is also continued pressure to reduce the presence of halogens in general, both in articles and generally in the environment. As many ESD additives contain halogens, the drive to reduce and/or eliminate halogen content creates difficulties when trying to maintain the ESD properties needed in many applications. The present invention provides a halogen-free ESD additive that provides good ESD performance while allowing for the reduction and/or elimination of halogen content in ESD materials. The present invention also overcomes one or more of the other problems associated with conventional ESD additives discussed above.

The present invention solves the problem of obtaining electrostatic dissipative polymers or additives which exhibit relatively low surface and volume resistivities without unacceptably high levels of extractable anions, in particular, chloride, nitrate, phosphate, and sulfate anions. These electrostatic dissipative polymers in turn can be incorporated in base polymer compositions useful in the electronics industry without producing other undesirable properties in a finished article of manufacture.

### SUMMARY OF THE INVENTION

The present invention provides a composition comprising: (a) an inherently dissipative polymer and (b) a halogen-free lithium-containing salt. In some embodiments, the halogen-free lithium-containing salt comprises a salt with the formula:

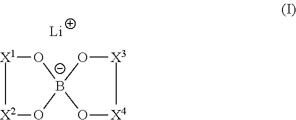

wherein each —X¹—, —X²—, —X³— and —X⁴— is independently —C(O)—, —C(R¹R²)—, —C(O)—C(R¹R2)— or —C(R¹R2)—C(R¹R²)— where each R¹ and R² is independently hydrogen or a hydrocarbyl group and wherein the R¹ and R² of a given X group may be linked to form a ring.

The halogen-free lithium-containing salt may also comprise a salt with the formula:

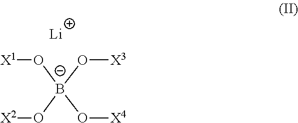

wherein each —X¹—, —X²—, —X³— and —X⁴— is independently —C(O)R¹, —C(R¹ R² R³), —C(O)— —C(R¹R²R³) or —C(R¹R2)— —C(R¹R²R³) where each R¹ and R² and R³ is independently hydrogen or a hydrocarbyl group and wherein the R¹, R²and/or R³ of a given X group may be linked to form a ring. In still further embodiments, the salt may be partially closed, that is groups X¹ and X² may be linked as they are in formula (I), having the definitions presented under formula (I), while groups X³ and X⁴ are not linked, as they are in formula (II), and having the definitions presented under formula (II).

In some embodiments, the inherently dissipative polymer comprises a thermoplastic elastomer and may also be a blend of at least two polymers. The thermoplastic elastomer may be a thermoplastic urethane, a copolyamide, copolyester ethers, polyolefin polyether copolymers, or combinations thereof.

The invention also provides a shaped polymeric article comprising the inherently dissipative polymer compositions described herein.

The invention also provides a process of making the inherently dissipative polymer compositions described herein. The process includes the step of mixing a halogen-free lithium-containing salt into an inherently dissipative polymer.

The compositions of the invention may have a surface resistivity of from about 1.0'10⁶ ohm/square to about 1.0×10¹² or about 1.0×10¹⁰ ohm/square as measured by ASTM D-257, and further the compositions may have less than about 8,000 parts per billion total extractable anions measured from the group of all four of chloride anions, nitrate anions, phosphate anions, and sulfate anions, and less than about 1,000 parts per billion of said chloride anions, less than about 100 parts per billion of said nitrate anions, less than about 6,000 parts per billion of said phosphate anions, and less than about 1,000 parts per billion of said sulfate anions.

### DETAILED DESCRIPTION OF THE INVENTION

Various features and embodiments of the invention will be described below by way of non-limiting illustration.

### The Inherently Dissipative Polymer

The compositions of the present invention include an inherently dissipative polymer. That is a polymer that has electrostatic dissipative (ESD) properties. In some embodiments, the polymer comprises a thermoplastic elastomer. Such materials may be generally described as polymers having in their backbone structures hard and/or crystalline segments and/or blocks in combination with soft and/or rubbery segments and/or blocks.

In some embodiments, the inherently dissipative polymer includes a thermoplastic polyurethane (TPU), a polyolefin polyether copolymer, a thermoplastic polyester elastomer (COPE), a polyether block amide elastomer (COPA or PEBA), or a combination thereof. Examples of suitable copolymers include polyolefin-polyether copolymers.

In some embodiments, the thermoplastic polyurethane is made by reacting at least one polyol intermediate with at least one diisocyanate and at least one chain extender. The polyol intermediate may be a polyether polyol and may be derived from at least one dialkylene glycol and at least one dicarboxylic acid, or an ester or anhydride thereof. The polyol intermediate may be a polyalkylene glycol and/or a poly(dialkylene glycol ester). Suitable polyalkylene glycols include polyethylene glycol, polypropylene glycol, polyethyleneglycol-polypropylene glycol copolymers, and combinations thereof. The polyol intermediate may also be a mixture of two or more different types of polyols. In some embodiments, the polyol intermediate includes a polyester polyol and a polyether polyol.

The polymer component may also be a blend of two or more polymers. Suitable polymers for use in such blends include any of the polymers described above. Suitable polymers also include a polyester-based TPU, a polyether-based TPU, a TPU containing both polyester and polyether groups, a polycarbonate, a polyolefin, a styrenic polymer, an acrylic polymer, a polyoxymethylene polymer, a polyamide, a polyphenylene oxide, a polyphenylene sulfide, a polyvinylchloride, a chlorinated polyvinylchloride or combinations thereof.

Suitable polymers for use in the blends described herein include homopolymers and copolymers. Suitable examples include:

(i) a polyolefin (PO), such as polyethylene (PE), polypropylene (PP), polybutene, ethylene propylene rubber (EPR), polyoxyethylene (POE), cyclic olefin copolymer (COC), or combinations thereof;

(ii) a styrenic, such as polystyrene (PS), acrylonitrile butadiene styrene (ABS), styrene acrylonitrile (SAN), styrene butadiene rubber (SBR or HIPS), polyalphamethylstyrene, styrene maleic anhydride (SMA), styrene-butadiene copolymer (SBC) (such as styrene-butadiene-styrene copolymer (SBS) and styrene-ethylene/butadiene-styrene copolymer (SEBS)), styrene-ethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof;

(iii) a thermoplastic polyurethane (TPU);

(iv) a polyamide, such as Nylon™, including polyamide 6,6 (PA66), polyamide 11 (PA11), polyamide 12 (PA12), a copolyamide (COPA), or combinations thereof;

(v) an acrylic polymer, such as polymethyl acrylate, polymethylmethacrylate, a methyl methacrylate styrene (MS) copolymer, or combinations thereof;

(vi) a polyvinylchloride (PVC), a chlorinated polyvinylchloride (CPVC), or combinations thereof;

(vii) a polyoxyemethylene, such as polyacetal;

(viii) a polyester, such as polyethylene terephthalate (PET), polybutylene terephthalate (PBT), copolyesters and/or polyester elastomers (COPE) including polyether-ester block copolymers such as glycol modified polyethylene terephthalate (PETG) polylactic acid (PLA), or combinations thereof;

(ix) a polycarbonate (PC), a polyphenylene sulfide (PPS), a polyphenylene oxide (PPO), or combinations thereof;

or combinations thereof.

Polyvinyl chloride (PVC), vinyl polymer, or vinyl polymer material, as used herein, refers to homopolymers and copolymers of vinyl halides and vinylidene halides and includes post halogenated polyvinyl halides such as CPVC. Examples of these vinyl halides and vinylidene halides are vinyl chloride, vinyl bromide, vinylidene chloride and the like. The vinyl halides and vinylidene halides may be copolymerized with each other or each with one or more polymerizable olefinic monomers having at least one terminal CH₂=C<grouping. As examples of such olefinic monomers there may be mentioned the alpha,beta-olefinically unsaturated carboxylic acids, such as acrylic acid, methacrylic acid, ethyl acrylic acid, alpha-cyano acrylic acid, and the like; esters of acrylic acid, such as methyl acrylate, ethyl acrylate, butyl acrylate, octyl acrylate, ethyl-cyano acrylate, hydroxyethyl acrylate, and the like; esters of methacrylic acid, such as methyl methacrylate, butyl methacrylate, hydroxyethyl methacrylate, and the like; nitriles, such as acrylonitrile, methacrylonitrile, and the like; acrylamides, such as methyl acrylamide, N-methylol acrylamide, N-butoxy methylacrylamide, and the like; vinyl ethers, such as ethyl vinyl ether, chloro ethyl vinyl ether, and the like; the vinyl ketones; styrene and styrene derivatives, such as alpha-methyl styrene, vinyl toluene, chlorostyrene, and the like; vinyl naphthalene, allyl and vinyl chloroacetate, vinyl acetate, vinyl pyridine, methyl vinyl ketone; the diolefins, including butadiene, isoprene, chloroprene, and the like; and other polymerizable olefinic monomers of the types known to those skilled in the art. In one embodiment, the polymer component includes polyvinyl chloride (PVC) and/or polyethylene terephthalate (PET).

Polymers suitable for use in the compositions of the present invention may also be described as polymers derived from low molecular weight polyether oligomers, wherein the polymers display relatively low surface and volume resistivities, yet generally are free of excessive levels of extractable anions.

The low molecular weight polyether oligomer useful in the present invention can comprise a homopolymer of ethylene oxide having a number average molecular weight of from about 200 to about 5000. The low molecular weight polyether oligomer can also comprise a copolymer of two or more copolymerizable monomers wherein one of the monomers is ethylene oxide and has a number average molecular weight from about 200 to about 20,000.

Exemplary of the comonomers which can be copolymerized with ethylene oxide are: 1,2-epoxypropane(propylene oxide); 1,2-epoxybutane; 2,3-epoxybutane(cis & trans); 1,2-epoxypentane; 2,3-epoxypentane(cis & trans); 1,2-epoxyhexane; 2,3-epoxyhexane(cis & trans); 3,4-epoxyhexane(cis & trans); 1,2-epoxy heptane; 1,2-epoxydecane; 1,2-epoxydodecane; 1,2-epoxyoctadecane; 7-ethyl-2-methyl-1,2-epoxyundecane; 2,6,8-trimethyl-1,2-epoxynonane; styrene oxide.

Other comonomers which can be used as comonomers with the ethylene oxide are: cyclohexene oxide; 6-oxabicyclo [3,1,0]-hexane; 7-oxabicyclo[4,1,0]heptane; 3-chloro-1,2-epoxybutane; 3-chloro-2,3-epxybutane; 3,3-dichloro-1,2-epoxypropane; 3,3,3-trichloro-1,2-epoxypropane; 3-bromo-1-2-epoxybutane, 3-fluoro-1 ,2-epoxybutane; 3-iodo-1 ,2-epoxybutane; 1,1-dichloro-1-fluoro-2,3-epoxypropane; 1-chloro-1,1-dichloro-2,3-epoxypropane; and 1,1,1,2-pentachloro-3 ,4-epoxybutane.

Typical comonomers with at least one ether linkage useful as co-monomers are exemplified by: ethyl glycidyl ether; n-butyl glycidyl ether; isobutyl glycidyl ether; t-butyl glycidyl ether; n-hexyl glycidyl ether; 2-ethylhexyl glycidyl ether; heptafluoroisopropyl glycidyl ether, phenyl glycidyl ether; 4-methyl phenyl glycidyl ether; benzyl glycidyl ether; 2-phenylethyl glycidyl ether; 1,2-dihydropentafluoroisopropyl glycidyl ether; 1,2-trihydrotetrafluoroisopropyl glycidyl ether; 1,1-dihydrotetrafluoropropyl glycidyl ether; 1,1-dihydranonafluoropentyl glycidyl ether; 1,1-dihydropentadecafluorooctyl glycidyl ether; 1,1-dihydropentadecafluorooctyl-alpha-methyl glycidyl ether; 1,1-dihydropentadecafluorooctyl-beta-methyl glycidyl ether; 1,1-dihydropentadecafluorooctyl-alpha-ethyl glycidyl ether; 2,2,2-trifluoro ethyl glycidyl ether.

Other comonomers with at least one ester linkage which are useful as comonomers to copolymerize with ethylene oxide are: glycidyl acetate; glycidyl chloroacetate; glycidyl butyrate; and glycidyl stearate; to name a few.

Typical unsaturated comonomers which can be polymerized with ethylene oxide are: allyl glycidyl ether; 4-vinylcyclohexyl glycidyl ether; alpha-terpinyl glycidyl ether; cyclohexenylmethyl glycidyl ether; p-vinylbenzyl glycidyl ether; allyphenyl glycidyl ether; vinyl glycidyl ether; 3,4-epoxy-1-pentene; 4,5-epoxy-2-pentene; 1,2-epoxy-5,9-cyclododecadiene; 3,4-epoxy-1-vinylchlohexene; 1,2-epoxy-5-cyclooctene; glycidyl acrylate; glycidyl methacrylate; glycidyl crotonate; glycidyl 4-hexenoate.

Other cyclic monomers suitable to copolymerize with ethylene oxide are cyclic ethers with four or more member-ring containing up to 25 carbon atoms except tetrahydropyran and its derivatives. Exemplary cyclic ethers with four or more member-ring are oxetane (1,3-epoxide), tetrahydrofuran (1,5-epoxide), and oxepane (1,6-epoxide) and their derivatives.

Other suitable cyclic monomers are cyclic acetals containing up to 25 carbon atoms. Exemplary cyclic acetals are trioxane, dioxolane, 1,3,6,9-tetraoxacycloundecane, trioxepane, troxocane, dioxepane and their derivatives.

Other suitable cyclic monomers are cyclic esters containing up to 25 carbon atoms. Exemplary cyclic esters are beta-valerolactone, epsilon-caprolactone, zeta-enantholactone, eta-capryllactone, butyrolactone and their derivatives. The low molecular weight polyether oligomer prepared by the method detailed immediately above then can be reacted with a variety of chain extenders and modified with a selected salt to form the electrostatic dissipative polymer additive or antistatic agent of the present invention.

A preferred embodiment of the polyester-ether block copolymer comprises the reaction product of ethylene glycol, terephthalic acid or dimethyl terephthalate and polyethylene glycol. These and other examples of other polyester-ether copolymers which can be utilized are set forth in the Encyclopedia of Polymer Science and Engineering, Vol. 12, John Wiley & Sons, Inc., NY, N.Y., 1988, pages 49-52, which is hereby fully incorporated by reference as well as U.S. Pat. Nos. 2,623,031; 3,651,014; 3,763,109; and 3,896,078.

Alternatively, the low molecular weight polyether oligomer can be reacted to form an electrostatic dissipative agent comprising one or more polyamide blocks as well as one or more low molecular weight polyether oligomer blocks. Alternatively, the low molecular weight polyether oligomer may be reacted with the polyamide in the presence of a diacid to form a polyether ester amide. Further information on this type of polymer can be found in U.S. Pat. No. 4,332,920.

Referring first to the polyester intermediate, a hydroxyl terminated, saturated polyester polymer is synthesized by reacting excess equivalents of diethylene glycol with considerably lesser equivalents of an aliphatic, preferably an alkyl, dicarboxylic acid having four to ten carbon atoms where the most preferred is adipic acid.

The hydroxyl terminated polyester oligomer intermediate is further reacted with considerably excess equivalents of non-hindered diisocyanate along with extender glycol in a so-called one-shot or simultaneous co-reaction of oligomer, diisocyanate, and extender glycol to produce the very high molecular weight linear polyurethane having an average molecular weight broadly from about 60,000 to about 500,000, preferably from about 80,000 to about 180,000, and most preferably from about 100,000 to about 180,000.

Alternatively, an ethylene ether oligomer glycol intermediate comprising a polyethylene glycol can be co-reacted with non-hindered diisocyanate and extender glycol to produce the high molecular weight, polyurethane polymer. Useful polyethylene glycols are linear polymers of the general formula H—(OCH₂ CH₂)ₙ—OH where n is the number of repeating ethylene ether units and n is at least 11 and between 11 and about 115. On a molecular weight basis, the useful range of polyethylene glycols have an average molecular weight from about 500 to about 5000 and preferably from about 700 to about 2500. Commercially available polyethylene glycols useful in this invention are typically designated as polyethylene glycol 600, polyethylene glycol 1500, and polyethylene glycol 4000.

In accordance with this invention, high molecular weight thermoplastic polyurethanes are produced by reacting together preferably in a one-shot process the ethylene ether oligomer glycol intermediate, an aromatic or aliphatic non-hindered diisocyanate, and an extender glycol. On a mole basis, the amount of extender glycol for each mole of oligomer glycol intermediate is from about 0.1 to about 3.0 moles, desirably from about 0.2 to about 2.1 moles, and preferably from about 0.5 to about 1.5 moles. On a mole basis, the high molecular weight polyurethane polymer comprises from about 0.97 to about 1.02 moles, and preferably about 1.0 moles of non-hindered diisocyanate for every 1.0 total moles of both the extender glycol and the oligomer glycol (i.e., extender glycol+oligomer glycol-1.0).

Useful non-hindered diisocyanates comprise aromatic non-hindered diisocyanates and include, for example, 1,4-diisocyanatobenzene (PPDI), 4,4′-methylene-bis(phenyl isocyanate) MDI), 1,5-naphthalene diisocyanate (NDI), m-xylene diisocyanate (XDI), as well as non-hindered, cyclic aliphatic diisocyanates such as 1,4-cyclohexyl diisocyanate (CHDI), and H₁₂ MDI. The most preferred diisocyanate is MDI. Suitable extender glycols (i.e., chain extenders) are aliphatic short chain glycols having two to six carbon atoms and containing only primary alcohol groups. Preferred glycols include diethylene glycol, 1,3-propane diol, 1,4-butane diol, 1,5-pentane diol, 1,4-cyclohexane-dimethanol, hydroquinone di(hydroxyethyl)ether, and 1,6-hexane diol with the most preferred glycol being 1,4-butane diol.

In accordance with the present invention, the hydroxyl terminated ethylene ether oligomer intermediate, the non-hindered diisocyanate, and the aliphatic extender glycol are co-reacted simultaneously in a one-shot polymerization process at a temperature above about 100° C. and usually about 120° C., whereupon the reaction is exothermic and the reaction temperature is increased to about 200° C. to above 250° C.

### The Halogen-Free Lithium-Containing Salt

The compositions of the present invention include halogen-free lithium-containing salt. In some embodiments, the salt is represented by the formula:

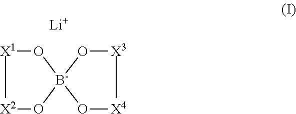

wherein each —X¹—, —X²—, —X³— and —X⁴— is independently —C(O)—, —C(R¹R²)—, —C(O)—C(R¹R²)— or —C(R¹R²)—C(R¹R²)— where each R¹ and R² is independently hydrogen or a hydrocarbyl group and wherein the R¹ and R² of a given X group may be linked to form a ring. In some embodiments the salt may be represented by formula (II) shown above, or any of the other embodiments described above.

In some embodiments, the salt is represent by Formula I wherein —X¹—, —X²—, —X³— and —X⁴— are —C(O)—.

Suitable salts also include the open, -ate structures of such salts, including Lithium bis(oxalate)borate.

In some embodiments, the halogen-free lithium-containing salt comprises lithium bis(oxalato)borate, lithium bis(glycolato)borate, lithium bis(lactato)borate, lithium bis(malonato)borate, lithium bis(salicylate)borate, lithium (glycolato,oxalato) borate, or combinations thereof.

While the exact mechanism of attachment and/or attraction of the salt to the polymer reaction product is not completely understood, the salt can unexpectedly improve the surface and volume resistivities of the resulting polymer, and may accomplish this without the presence of unacceptably high levels of extractable anions. Moreover, the static decay times remain in an acceptable range, that is, the times are not too fast or too slow.

The compositions of the present invention may also contain one or more additional salts that are effective as an ESD additive. In some embodiments, these additional salts include metal-containing salts that contain a metal other than lithium. These additional salts may also include halogen-containing salts. Such salts include metal-containing salts, salt complexes, or salt compounds formed by the union of metal ion with a non-metallic ion or molecule. The amount of salt present may be an amount effective to provide improved ESD properties to the overall composition. The optional salt component may be added during the one-shot polymerization process.

Examples of additional salts useful in the present invention include: LiClO₄, LiN(CF₃SO₂)₂, LiPF₆, LiAsF₆, LiI, LiCl, LiBr, LiSCN, LiSO₃ CF₃, LiNO₃, LiC(SO₂CF₃)₃, Li₂S, and LiMR₄, where M is Al or B, and R is a halogen, hydrocarbyl, alkyl or aryl group. In one embodiment, the salt is Li N(CF₃ SO₂)₂, which is commonly referred to as lithium trifluoromethane sulfonamide, or the lithium salt of trifluoromethane sulfonic acid. The effective amount of the selected salt added to the one-shot polymerization may be at least about 0.10, 0.25, or even 0.75 parts by weight based on 100 parts by weight of the polymer.

In some embodiments, the compositions of the present invention further comprises a sulfonate-type anionic antistatic agent. Suitable examples include metal alkylsulfonates and metal alkyl-aromatic sulfonates. The metal alkylsulfonates can include alkali metal or alkaline earth metal aliphatic sulfonates in which the alkyl group has 1 to 35 or 8 to 22 carbon atoms. The alkali metals may include sodium and potassium and the alkaline earth metals may include calcium, barium and magnesium. Specific examples of metal alkylsulfonates include sodium n-hexylsulfonate, sodium n-heptylsulfonate, sodium n-octylsulfonate, sodium n-nonylsulfonate, sodium n-decylsulfonate, sodium n-dodecylsulfonate, sodium n-tetradecylsulfonate, sodium n-hexadecylsulfonate, sodium n-heptadecylsulfonate and sodium n-octadecylsulfonate. Specific examples of metal alkyl-aromatic sulfonates include alkali metal or alkaline earth metal salts of sulfonic acids comprising 1 to 3 aromatic nuclei substituted with an alkyl group having 1 to 35 or 8 to 22, carbon atoms. The aromatic sulfonic acids include, for example, benzenesulfonic, naphthalene-1-sulfonic, naphthalene-2,6-disulfonic, diphenyl-4-sulfonic and diphenyl ether 4-sulfonic acids. Metal alkyl-aromatic sulfonates include, for example, sodium hexylbenzenesulfonate, sodium nonylbenzenesulfonate and sodium dodecylbenzenesulfonate. In other embodiments, the compositions of the present invention are substantially free to free of sulfonate-type anionic antistatic agents.

The compositions of the present invention may also include an non-metal containing anti-stat additives, such as ionic liquids. Suitable liquids include tri-n-butylmethylammonium bis-(trifluoroethanesulfonyl)imide (available as FC-4400 from 3M™), one or more the Basionics™ line of ionic liquids (available from BASF™), and similar materials.

In some embodiments, the present invention allows for the use of co-solvent with the metal containing salt. The use of a co-solvent, may in some embodiments, allow a lower charge of salt to provide the same benefit in ESD properties. Suitable co-solvents include ethylene carbonate, propylene carbonate, dimethyl sulfoxide, tetramethylene sulfone, tri- and tetra ethylene glycol dimethyl ether, gamma butyrolactone, and N-methyl-2-pyrrolidone. When present, the co-solvent may be used at least about 0.10, 0.50 or even 1.0 parts by weight based on 100 parts by weight of the polymer. In some embodiments, the compositions of the present invention are substantially free to free of any or all of the co-solvents described herein.

In other embodiments, the compositions of the present invention are substantially free to free of any or all of the metal containing salts described herein and/or substantially free to free of any ESD additives except for the non-halogen lithium-containing salts described above.

The effective amount of the selected salt in the overall composition may be at least about 0.10 parts based on 100 parts of the polymer, and in some embodiments at least about 0.25 parts or even at least about 0.75 parts. In some embodiments, these amounts are with respect to each individual salt present in the composition. In other embodiments, the amounts apply to the total amount of all salts present in the composition.

### Additional Additives

The compositions of the present invention may further include additional useful additives, where such additives can be utilized in suitable amounts. These optional additional additives include opacifying pigments, colorants, mineral and/or inert fillers, stabilizers including light stabilizers, lubricants, UV absorbers, processing aids, antioxidants, antiozonates, and other additives as desired. Useful opacifying pigments include titanium dioxide, zinc oxide, and titanate yellow. Useful tinting pigments include carbon black, yellow oxides, brown oxides, raw and burnt sienna or umber, chromium oxide green, cadmium pigments, chromium pigments, and other mixed metal oxide and organic pigments. Useful fillers include diatomaceous earth (superfloss) clay, silica, talc, mica, wallostonite, barium sulfate, and calcium carbonate. If desired, useful stabilizers such as antioxidants can be used and include phenolic antioxidants, while useful photostabilizers include organic phosphates, and organotin thiolates (mercaptides). Useful lubricants include metal stearates, paraffin oils and amide waxes. Useful UV absorbers include 2-(2′-hydroxyphenyl) benzotriazoles and 2-hydroxybenzophenones. Additives can also be used to improve the hydrolytic stability of the TPU polymer. Each of these optional additional additives described above may be present in, or excluded from, the compositions of the present invention.

When present, these additional additives may be present in the compositions of the present invention from 0 or 0.01 to 5 or 2 weight percent of the composition. These ranges may apply separately to each additional additive present in the composition or to the total of all additional additives present.

### Industrial Application

The compositions described herein are prepared by mixing the halogen-free lithium-containing salt described above into the inherently dissipative polymer described above. In addition, one or more additional salts, polymers and/or additives may be present. The salt may be added to the polymer in various ways, some which may be defined as a chemical or in-situ process and some which may be defined as a physical or mixing process.

In some embodiments, the halogen-free lithium-containing salt is added to the inherently dissipative polymer during the polymerization of the polymer, resulting in the inherently dissipative polymer composition.

In some embodiments, the halogen-free lithium-containing salt is added to the inherently dissipative polymer via wet absorption, resulting in the inherently dissipative polymer composition.

In some embodiments, the halogen-free lithium-containing salt is compounded and/or blended into the inherently dissipative polymer, resulting in the inherently dissipative polymer composition.

The resulting compositions of the present invention include one or more of the inherently dissipative polymers described above in combination with one or more of the halogen-free lithium-containing salts described above. The compositions may include an effective amount of the salt, said salt being compatible with the polymer, such that the resulting composition has a surface resistivity of from about 1.0×10⁶ ohm/square to about 1.0×10¹⁰ ohm/square as measured by ASTM D-257, and further the salt-modified polymer having less than about 8,000 parts per billion total extractable anions measured from the group of all four of chloride anions, nitrate anions, phosphate anions, and sulfate anions, and less than about 1,000 parts per billion of said chloride anions, less than about 100 parts per billion of said nitrate anions, less than about 6,000 parts per billion of said phosphate anions, and less than about 1,000 parts per billion of said sulfate anions.

In some embodiments, the compositions of the present invention are substantially free to free of fluorine atoms, chlorine atoms, bromine atoms, iodine atoms, astatine atoms, or combinations thereof (including ions of said atoms). In some embodiments, the compositions of the present invention are substantially free to free of salts and/or other compounds containing fluorine, chlorine, bromine, iodine, and/or astatine atoms, and/or ions of one or more thereof. In some embodiments, the compositions of the present invention are substantially free to free of all halogens atoms, halogen-containing salts, and/or other halogen-containing compounds. By substantially free, it is meant that the compositions contain less than 10,000 parts per million or even 10,000 parts per billion of fluorine/fluoride, chorine/chloride, bromine/bromide, iodine/iodide, astatine/astatide, or combinations of the atoms/ions thereof.

These polymer compositions are useful in forming a plastic alloy for use with an electronic device, due to their beneficial ESD and/or inherently dissipative properties. The compositions may be used in the preparation of polymeric articles, especially where ESD properties are of a concern. Examples of applications in which the compositions described above may be used building and construction materials and equipment, machine housings, manufacturing equipment, and polymeric sheets and films. More specifically, examples include: fuel handling equipment such as fuel lines and vapor return equipment; business equipment; coatings for floors such as for clean rooms and construction areas; clean room equipment such as garments, floorings, mats, electronic packaging, housings, chip holders, chip rails, tote bins and tote bin tops; medical applications; battery parts such as dividers and/or separators, etc. The compositions of the present invention may be used in any articles that require some level of ESD properties.

In one embodiment, the compositions of the present invention are used to make polymeric articles to be used as: packaging materials for electronic parts; internal battery separators for use in the construction of lithium-ion batteries; clean room supplies and construction materials; antistatic conveyor belts; fibers; parts for office machines; antistatic garments and shoes, or combinations thereof.

The compositions can be used with various melt processing techniques including injection molding, compression molding, slush molding, extrusion, thermoforming cast, rotational molding, sintering, and vacuum molding. Articles of this invention may also be made from resins produced by the suspension, mass, emulsion or solution processes.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLES

The invention will be further illustrated by the following examples, which sets forth particularly advantageous embodiments. While the examples are provided to illustrate the present invention, they are not intended to limit it.

### Example Set 1

A set of ESD compositions is prepared by mixing a PEG-based TPU with lithium bis(oxalate)borate salt. The salt is added to the TPU via wet absorption. Several samples are prepared at different salt levels and the ESD properties of the compositions are measured. The results of this testing are summarized in the table below.

TABLE I
Properties of ESD TPU Compositions

| | Comp Ex | Example | Example | Example | Example |
|---|---|---|---|---|---|
| | 1-A | 1-B | 1-C | 1-D | 1-E |
| % wt salt | 0.0 | 0.5 | 1.0 | 1.5 | 2.0 |
| in the | | | | | |
| composition | | | | | |
| Surface | 8.5E+09 | 8.8E+08 | 5.0E+08 | 5.3E+08 | 2.3E+08 |
| Resistivity¹ | | | | | |
| (ohms/sq) | | | | | |
| Volume | 4.0E+09 | 1.8E+08 | 1.1E+08 | 1.7E+08 | 8.0E+07 |
| Resistivity¹ | | | | | |
| (ohm-cm) | | | | | |

¹Resistivity is measured per ASTM D257 at 50% relative humidity

### Example Set 2

A set of ESD compositions is prepared by mixing a various polymers with lithium bis(oxalate)borate salt. The amount of salt present in each example is 2 percent by weight of the overall composition. The ESD properties of the compositions are measured. The results of this testing are summarized in the table below.

TABLE II
Properties of ESD Polymer Compositions

| | Example | Example | Example | Example | Example |
|---|---|---|---|---|---|
| | 2-A | 2-B | 2-C | 2-D | 2-E |
| % wt salt in the composition | 2.0 | 2.0 | 2.0 | 2.0 | 2.0 |
| Inherently Dissipative | PEBAX ™ | PEBAX ™ | HYTREL ™ | HYTREL ™ | PELESTAT ™ |
| Polymer in the composition | MV1074 | 1657 | G3548L | 4774 | NC6321 |
| Surface Resistivity¹ (ohms/sq) | 3.8E+08 | 1.2E+08 | 1.4E+09 | 1.2E+09 | 2.1E+08 |
| Volume Resistivity¹ (ohm-cm) | 8.7E+07 | 3.9E+07 | 2.9E+08 | 8.7E+08 | 4.8E+07 |
| Static Decay (1000 V-10 V, s) | 0.0 | 0.0 | 0.0 | 0.0 | 0.0 |

¹Resistivity is measured per ASTM D257 at 50% relative humidity
2 - Static decay is measured per FTMS-101C at 12% relative humidity. The static decay rate measures the time it takes for an article made of the example material to discharge the indicated starting voltage and reach the indicated ending voltage.

### Example Set 3

A set of fully formulated ESD compositions is prepared by mixing a polyethylene glycol (PEG) based thermoplastic polyurethane (TPU) into glycol-modified polyethylene terephthalate (PETG) based formulations and adding an additional additive package. The PEG-based TPU is mixed with a salt, and a different salt is used in each example. Comparative Example 3-A contains lithium (bis)trifluoromethane-sulfonimide, a halogen-containing lithium salt, at a treat rate of about 0.4% by weight. Example 3-B contains lithium bis(oxalate)borate salt, a halogen-free lithium salt, at a treat rate of about 0.3% by weight. The ESD properties of the compositions are measured. The results of this testing are summarized in the table below.

TABLE III
Properties of ESD TPU Polymer Compositions

| | Comp Ex | Example |
|---|---|---|
| | 3-A | 3-B |
| Surface Resistivity¹ (ohms/sq) | 5.5E+08 | 4.6E+08 |
| Volume Resistivity¹ (ohm-cm) | | |
| Static Decay (1000 V-10 V, s) | 0.1 | 0.1 |

¹Resistivity is measured per ASTM D257 at 50% relative humidity
2 - Static decay is measured per FTMS-101C at 12% relative humidity.

### Example Set 4

A set of ESD compositions is prepared by mixing a PEG-based TPU into PETG-based formulations. The PEG-based TPU used in each example is mixed with a salt. Comparative Example 4-A contains lithium (bis)trifluoromethane-sulfonimide, a halogen-containing lithium salt. The Inventive Examples contain lithium bis(oxalate)borate salt, a halogen-free lithium salt. The ESD properties of the compositions are measured. The results of this testing are summarized in the table below.

TABLE IV
Properties of ESD Polymer Compositions

| | Comp Ex | Example | Example | Example | Example |
|---|---|---|---|---|---|
| | 4-A | 4-B | 4-C | 4-D | 4-E |
| Halogen- | NO | YES | YES | YES | YES |
| Free Salt | | | | | |
| % wt salt | 3.0 | 1.0 | 1.2 | 1.4 | 1.6 |
| in the | | | | | |
| PEG TPU | | | | | |
| Surface | 3.2E+09 | 5.9E+09 | 5.7E+09 | 7.0E+09 | 6.6E+09 |
| Resistivity¹ | | | | | |
| (ohms/sq) | | | | | |
| Volume | 1.3E+09 | 1.3E+09 | 1.3E+09 | 1.2E+09 | 1.2E+09 |
| Resistivity¹ | | | | | |
| (ohm-cm) | | | | | |
| Static Decay | 0.2 | 0.2 | 0.2 | 0.2 | 0.2 |
| (1000 | | | | | |
| V-10 V, s) | | | | | |

¹Resistivity is measured per ASTM D257 at 50% relative humidity
2 - Static decay is measured per FTMS-101C at 12% relative humidity.

### Example Set 5

A set of fully formulated ESD compositions is prepared by mixing a PEG-based TPU and a PETG-based TPU along with an additional additive package. The PEG-based TPU used in each example is mixed with a salt. Comparative Example 5-A contains lithium (bis)trifluoromethanesulfonimide, a halogen-containing lithium salt, at a treat rate of about 0.05% by weight. The Inventive Example contains lithium bis(oxalate)borate salt, a halogen-free lithium salt, at a treat rate of about 0.04% by weight. The ESD properties of the compositions are measured. The results of this testing are summarized in the table below.

TABLE V
Properties of ESD TPU Polymer Compositions

| | Comp Ex | Example |
|---|---|---|
| | 5-A | 5-B |
| Surface Resistivity¹ (ohms/sq) | 3.1E+09 | 4.4E+09 |
| Volume Resistivity¹ (ohm-cm) | 2.5E+09 | 3.3E+09 |
| Static Decay (1000 V-10 V, s) | 7.3 | 9.0 |

¹Resistivity is measured per ASTM D257 at 50% relative humidity
2 - Static decay is measured per FTMS-101C at 12% relative humidity.

### Example Set 6

A set of fully formulated ESD compositions is prepared by mixing a PEG-based TPU and an acrylic polymer along with an additional additive package. The PEG-based TPU used in each example is mixed with a salt. Comparative Example 6-A contains lithium (bis)trifluoromethanesulfonimide, a halogen-containing lithium salt, at a treat rate of about 0.09% by weight. The Inventive Example contains lithium bis(oxalate)borate salt, a halogen-free lithium salt, at a treat rate of about 0.07% by weight. The ESD properties of the compositions are measured. The results of this testing are summarized in the table below.

TABLE VI
Properties of ESD Acrylic Polymer Compositions

| | Comp Ex | Example |
|---|---|---|
| | 6-A | 6-B |
| Surface Resistivity¹ (ohms/sq) | 2.3E+09 | 3.1E+09 |
| Volume Resistivity¹ (ohm-cm) | 2.4E+09 | 3.9E+09 |
| Static Decay (1000 V-10 V, s) | 5.2 | 5.7 |

¹Resistivity is measured per ASTM D257 at 50% relative humidity
2 - Static decay is measured per FTMS-101C at 12% relative humidity.

### Example Set 7

A set of fully formulated ESD compositions is prepared by mixing a PEG-based TPU and a polypropylene-based polymer along with an additional additive package. The PEG-based TPU used in each example is mixed with a salt. Comparative Example 7-A contains lithium (bis)trifluoromethanesulfonimide, a halogen-containing lithium salt, at a treat rate of about 0.4% by weight. The Inventive Example contains lithium bis(oxalate)borate salt, a halogen-free lithium salt, at a treat rate of about 0.3% by weight. The ESD properties of the compositions are measured. The results of this testing are summarized in the table below.

TABLE VII
Properties of ESD PP Polymer Compositions

| | Comp Ex | Example |
|---|---|---|
| | 7-A | 7-B |
| Surface Resistivity¹ (ohms/sq) | 4.4E+10 | 6.5E+10 |
| Volume Resistivity¹ (ohm-cm) | 9.0E+10 | 1.4E+11 |
| Static Decay (1000 V-10 V, s) | 3.2 | 5.2 |

¹Resistivity is measured per ASTM D257 at 50% relative humidity
2 - Static decay is measured per FTMS-101C at 12% relative humidity.

### Example Set 8

A set of fully formulated ESD compositions is prepared by mixing a PEG-based TPU and a styrenic-based polymer along with an additional additive package. The PEG-based TPU used in each example is mixed with a salt. Comparative Example 8-A contains lithium (bis)trifluoromethanesulfonimide, a halogen-containing lithium salt, at a treat rate of about 0.3% by weight. The Inventive Example contains lithium bis(oxalate)borate salt, a halogen-free lithium salt, at a treat rate of about 0.2% by weight. The ESD properties of the compositions are measured. The results of this testing are summarized in the table below.

TABLE VIII
Properties of ESD Styrenic Polymer Compositions

| | Comp Ex | Example |
|---|---|---|
| | 8-A | 8-B |
| Surface Resistivity¹ (ohms/sq) | 3.7E+09 | 1.1E+10 |
| Volume Resistivity¹ (ohm-cm) | 4.3E+09 | 8.7E+09 |
| Static Decay (1000 V-10 V, s) | 0.4 | 1.0 |

¹Resistivity is measured per ASTM D257 at 50% relative humidity
2 - Static decay is measured per FTMS-101C at 12% relative humidity.

The results show that the compositions of the present invention, which utilize a halogen-free lithium containing salt, provide ESD properties comparable to those obtained by the use of halogen-containing salts and similar ESD additives.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, all percent values, ppm values and parts values are on a weight basis. Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, and unless otherwise defined, the expression “substantially free of” may mean that and amount that does not materially affect the basic and novel characteristics of the composition under consideration, in some embodiments it may also mean no more than 5%, 4%, 2%, 1%, 0.5% or even 0.1% by weight of the material is questions is present, in still other embodiments it may mean that less than 1,000 ppm, 500 ppm or even 100 ppm of the material in question is present. As used herein, the expression “consisting essentially of” permits the inclusion of substances that do not materially affect the basic and novel characteristics of the composition under consideration.

1. A composition comprising:
(a) an inherently dissipative polymer;
(b) a halogen-free lithium-containing salt.

2. The composition of claim 1 wherein the halogen-free lithium-containing salt comprises a salt with the formula: 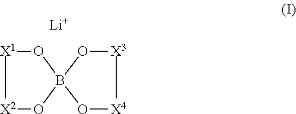
wherein each —X¹—, —X2—, —X3— and —X4— is independently —C(O)—, —C(R₁R2)—, —C(O)—C(R₁R2)— or —C(R₁R2)—C(R₁R2)— where each R₁ and R₂ is independently hydrogen or a hydrocarbyl group and wherein the R₁ and R₂ of a given X group may be linked to form a ring.

3. The composition of claim 1 wherein the halogen-free lithium-containing salt comprises lithium bis(oxalato)borate, lithium bis(glycolato)borate, lithium bis(lactato)borate, lithium bis(malonato)borate, lithium bis(salicylate)borate, lithium (glycolato,oxalato)borate, or combinations thereof.

4. The composition of claim 1 wherein the composition further comprises one or more additional lithium-containing salts.

5. The composition of claim 1 wherein the inherently dissipative polymer comprises a thermoplastic elastomer.

6. The composition of claim 1 wherein the inherently dissipative polymer comprises a thermoplastic polyurethane (TPU), a polyolefin polyether copolymer, a thermoplastic polyester elastomer (COPE), a polyether block amide elastomer (COPA), or a combination thereof.

7. The composition of claim 1 wherein the inherently dissipative polymer comprises a thermoplastic polyurethane composition made by reacting (a) at least one polyether polyol intermediate with (b) at least one diisocyanate and (c) at least one chain extender; wherein (a), the polyether polyol intermediate comprises an intermediate derived from at least one dialkylene glycol and at least one dicarboxylic acid, or an ester or anhydride thereof; and wherein (a) may optionally further comprise a polyester polyol.

8. The composition of claim 1 wherein the inherently dissipative polymer comprises a blend of at least two polymers.

9. The composition of claim 8 wherein the blend of polymer comprises two or more of:
a polyester-based TPU, a polyether-based TPU, a TPU containing both polyester and polyether groups, a polycarbonate, a polyolefin, a styrenic polymer, an acrylic polymer, a polyoxymethylene polymer, a polyamide, a polyphenylene oxide, a polyphenylene sulfide, a polyvinylchloride, a chlorinated polyvinylchloride or combinations thereof.

10. A shaped polymeric article comprising the inherently dissipative polymer composition of claim 1.

11. The polymeric article of claim 10, wherein the article comprises: packaging materials for electronic parts; internal battery separators for use in the construction of lithium-ion batteries; parts for clean room equipment and applications; fibers; or combinations thereof.

12. A process of making an inherently dissipative polymer composition comprising the steps of:
I. mixing a halogen-free lithium-containing salt into an inherently dissipative polymer.

13. The process of claim 12 wherein the halogen-free lithium-containing salt is added to the inherently dissipative polymer during the polymerization of the polymer, resulting in the inherently dissipative polymer composition.

14. The process of claim 12 wherein the halogen-free lithium-containing salt is added to the inherently dissipative polymer via wet absorption, resulting in the inherently dissipative polymer composition.

15. The process of claim 12 wherein the halogen-free lithium-containing salt is compounded into the inherently dissipative polymer, resulting in the inherently dissipative polymer composition.
